(19) United States
(12) Patent Application Publication
(10) Pub. No.: US 2007/0154222 A1
(43) Pub. Date: Jul. 5, 2007

(54) Half duplex type optical connection structure and optical device suitable for the same

(75) Inventors: Seung-Woo Kim, Anyang-si (KR); In Kim, Suwon-si (KR); Jeong-Seok Lee, Anyang-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/592,304

(22) Filed: Nov. 2, 2006

(30) Foreign Application Priority Data
Dec. 29, 2005 (KR) 133743/2005

(51) Int. Cl. H04B 10/12

(52) U.S. Cl. 398/141

(57) ABSTRACT

Disclosed is an optical connection structure of half-duplex transmission type and an optical device suitable for the same. The optical connection structure of half-duplex type comprises two or more signal transmitting/receiving units, which are interconnected through an optical waveguide, wherein each of the signal transmitting/receiving units comprises an optical device having a light source for producing and emitting optical signals to the outside through an opening, and a photodetector for receiving the optical signals incident thereto and converting the optical signals into electric signals, the light source and the photodetector being integrated with each other; and a control unit, which in the signal transmitting mode, drives the light source, so that the corresponding signal transmitting/receiving unit functions as a light source, and in the signal receiving mode, drives the photodetector, so that the corresponding signal transmitting/receiving unit functions as a photodetector.

### CLAIM OF PRIORITY

This application claims the benefit of the earlier filing date, pursuant to 35 USC 119, to that patent application entitled “Half-Duplex Type Optical Connection Structure And Optical Device Suitable For The Same,” filed with the Korean Intellectual Property Office on Dec. 29, 2005 and assigned Serial No. 2005-133743, the contents of which are hereby incorporated by reference.

### BACKGROUND OF THE INVENTION

1. Field of the Invention

The present invention relates to an optical connection structure, and in particular to a half duplex type optical connection structure and an optical device suitable for the structure.

2. Description of the Related Art

As the functions of portable terminals have been improved and compositely combined, serial interfaces are being developed that are capable of increasing data transmission capacity and simplifying the interconnection of a main body and a display device of a portable terminal, thereby improving the reliability of the portable terminal and reducing the power consumption of the portable terminal. An interconnection through a flexible PCB has a limitation in increasing data transfer rate as EMI is also increased when the data transmission capacity is increased. Therefore, if the EMI related problem and the problem of the increase in data to be transmitted are solved without increasing the number of channels, it is possible to secure a wiring space within a portable terminal that tends toward miniaturization.

In general, in an optical connection, a signal transmitting stage requires a laser diode to transmit signals and an optical signal receiving stage including a photo diode optically coupled with an optical waveguide to receive signals.

Accordingly, in a duplex signal transmission, there is a problem in that at least two pairs of laser diodes and photo diodes are needed and typically are optically coupled using different optical waveguides. In particular, in an optical connection required in a wireless terminal, it may be necessary to provide two or more communication lines, each of which occasionally requires a duplex transmission link or type. In such a case, there is a disadvantage in that the number of laser diodes and photo diodes increases depending on the number of the communication lines and the process for optically coupling them becomes complicated.

Meanwhile, in the half-duplex transmission link or type, two communication devices are coupled through an optical waveguide. When one communication device transmits signals, the corresponding signal receiving unit is in an non-operating (standby) state while the signal receiving unit in the other communication devices is in a operating state. In the case when two communication devices concurrently transmit and receive signals, if one device sends signals, the other device is necessarily in the signal receiving mode.

Therefore, what is needed is an optical device, within which a laser diode and a photo diode can be integrated in a manner that they are separately operated in a signal transmitting mode and a signal receiving mode, and an optical connection structure employing such optical devices.

### SUMMARY OF THE INVENTION

The present invention has been made to solve the above-mentioned problems occurring in the prior art and provides additional advantages, by providing a half-duplex type optical connection structure and an optical device suitable for the same.

In one embodiment, there is provided a half-duplex type optical connection structure (system) including two or more signal transmitting/receiving units, which are interconnected through an optical waveguide, wherein each of the signal transmitting/receiving units includes an optical device having a light source for producing and emitting optical signals to the outside through an opening, and a photodetector for receiving the optical signals incident through the opening and converting the optical signals into electric signals, the light source and the photodetector being integrated with each other, and a control unit, which in the signal transmitting mode, drives the light source so that the corresponding signal transmitting/receiving unit functions as a light source, and in the signal receiving mode, drives the photodetector so that the corresponding signal transmitting/receiving unit functions as a photodetector.

Preferably, the control unit may include a light source driver for driving the light source of the optical device, a transimpedance amplifier (TIA) for amplifying and outputting the electric signals supplied from the photodetector, and a switch, which in the signal transmitting mode, interconnects the light source driver and the light source, and in the signal receiving mode interconnects the photodetector and the transimpedance amplifier.

### BRIEF DESCRIPTION OF THE DRAWINGS

The above features and advantages of the present invention will be more apparent from the following detailed description taken in conjunction with the accompanying drawings, in which:

FIG. 1 is a block diagram illustrating a half-duplex type optical connection structure according to an embodiment of the present invention;

FIG. 2 is a schematic view illustrating an example of a photodetector integrated vertical cavity surface emitting laser suitable for the half-duplex type optical connection structure shown herein;

FIG. 3 is a schematic view illustrating a case in which the photodetector integrated vertical cavity surface emitting laser of FIG. 2 is applied to the optical connection structure;

FIG. 4 is a schematic view illustrating another example of a photodetector integrated vertical cavity surface emitting laser (VCSEL) suitable for the half-duplex type optical connection structure shown herein;

FIG. 5 is a top view of the photodetector integrated vertical cavity surface emitting laser shown in FIG. 4; and

FIG. 6 shows a case in which the photodetector integrated vertical cavity surface emitting laser of FIG. 4 is applied to the optical connection structure of FIG. 1.

### DETAILED DESCRIPTION OF THE INVENTION

Hereinafter, embodiments of the present invention will be described with reference to the accompanying drawings. For the purposes of clarity and simplicity, a detailed description of known functions and configurations incorporated herein will be omitted as it may make the subject matter of the present invention rather unclear.

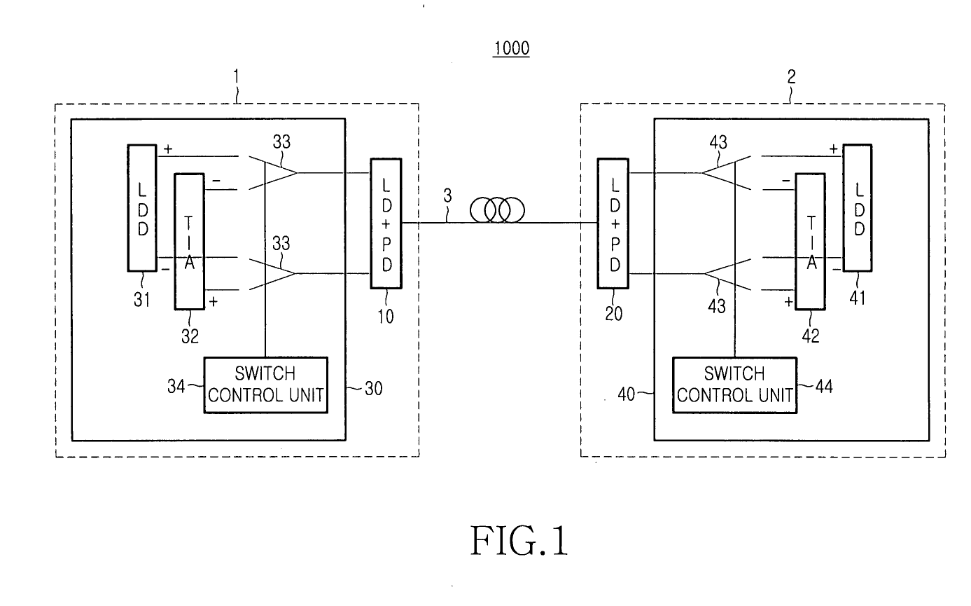

FIG. 1 is a block diagram illustrating a half-duplex type optical connection structure according to an embodiment of the present invention.

Referring to FIG. 1, the inventive half-duplex type optical connection structure 1000 includes first and second signal transmitting/receiving units 1 and 2, which are optically coupled with each other through an optical waveguide 3. Each of the first and second signal transmitting/receiving units 1 and 2 has an optical device 10, 20, respectively, and a control unit 30, 40, respectively, for controlling the corresponding optical device. In addition, each of the control units 30 and 40 has a light source driver 31, 41, a transimpedance amplifier (TIA) 32, 42, a switch 33, 43, and a switch control unit 34, 44, respectively.

Each of the optical devices 10 and 20 is formed by integrating a light source LD as a single chip (integrally), wherein the light source generates and emits optical signals to the outside through an opening and the photo detector PD receives optical signals incident through the opening and converts the received optical signals into electric signals, whereby the optical devices 1 and 2 function as a light source in the signal transmitting mode and function as a photo detector in the signal receiving mode.

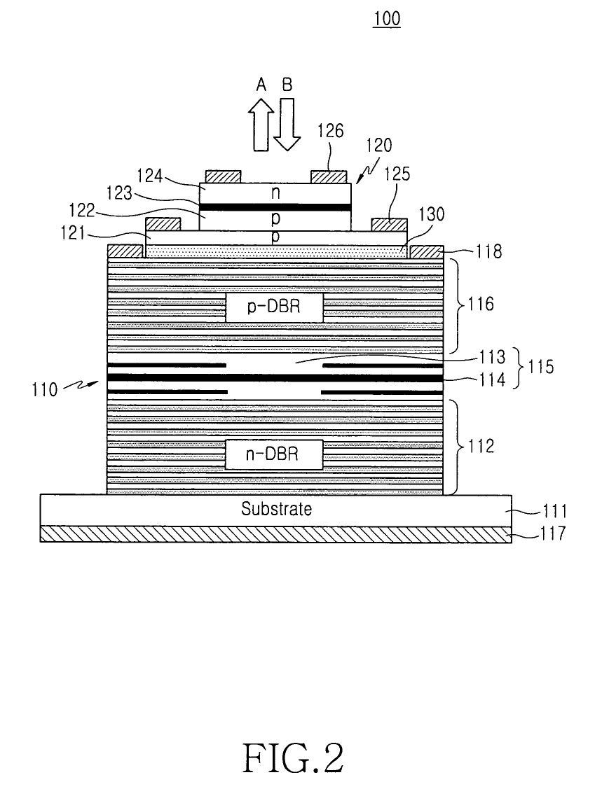

FIG. 2 is a schematic view illustrating an example of a photodetector integrated vertical cavity surface emitting laser (VCSEL) as an optical device suitable for the half-duplex type optical connection structure in accordance with the principles of the invention.

Referring to FIG. 2, the inventive photodetector integrated vertical cavity surface emitting laser 100 includes a light source 110, and a photodetector 120 of p-i-n structure formed on the top of the light source 110.

The light source 110 includes an n-doped GaAs substrate 111, a lower reflector layer 112 formed by laminating plural mirrors of n-type semiconductor material on the top of the substrate 111, an active layer 115 provided on the top of the lower reflector layer 112, an upper reflector layer 116 formed by laminating plural mirrors, which are formed of p-type semiconductor material, on the active layer 115, a bottom electrode 117 formed on the rear side of the substrate 111, and a top electrode 118 coupled to the top of the upper reflector layer 116 and having a central cavity. In addition, the active layer 115 includes a current concentration area 113, to which electric current is concentrated, and a high resistance area 114 for suppressing spontaneous emission of light, which is laterally projected.

When a voltage V_{LD}, for driving the light source, is applied to the bottom electrode 117 and the top electrode 118 is earthed (grounded), a laser light beam is produced from the active layer by the applied voltage. The light, being reflected by the lower and upper reflector layers 112 and 116, which are high in reflectivity, the produced beam is amplified. As such, when the produced laser light beam arrives at a predetermined wavelength, the produced laser beam passes the two reflector layers and is projected in the opposite directions substantially perpendicular to the substrate 111.

The photodetector 120 is laminated over the cavity of the light source 110 and includes a p-type buffer layer 121, a p-type doped layer 122, a light absorbing layer 123, an n-type doped layer 124, and top and bottom electrodes 125 and 126. The electrode 126 for the photodetector 120 has a central cavity, through which most of the beam projected from the light source passes. The laser beam, which has passed through the central cavity, is used as the output light “A” of the VSCEL.

An isolation layer 130 is further interposed between the light source 110 and the photodetector 120, so that simultaneously with driving the light source 110, a bias voltage can be independently and forwardly applied to the photodetector 120 of p-i-n structure to the extent of a turn-on voltage.

Referring to FIG. 1, the control units 30 and 40 are respectively positioned in the first and second signal transmitting/receiving units, and each of the control units 30 and 40 includes a light source driver 31, 41 for driving the light source LD of the corresponding optical device 10, 20, a transimpedance amplifier (TIA) 32, 42 for amplifying and outputting the electric signals outputted from the corresponding optical device 10, 20, a switch 33, 43, and a switch control unit 34, 44.

In each of the signal transmitting mode and the signal receiving mode, the switch control units 34 and 44 control the switches 33 and 43, respectively, for electrically connecting the optical devices 20, the light source drivers 31 and 41, and the transimpedance amplifiers 32 and 42, respectively.

In the signal transmitting mode, the light source LD 10 of the optical device 1 and the light source driver 31 are electrically connected, so that light to be transmitted is produced, and in the signal receiving mode, the connection between the light source LD 10 and the light source driver 31 is cut off, thereby turning off the light source, and the photodetector PD and the TIA are electrically connected, so that photocurrent is produced from the photodetector PD.

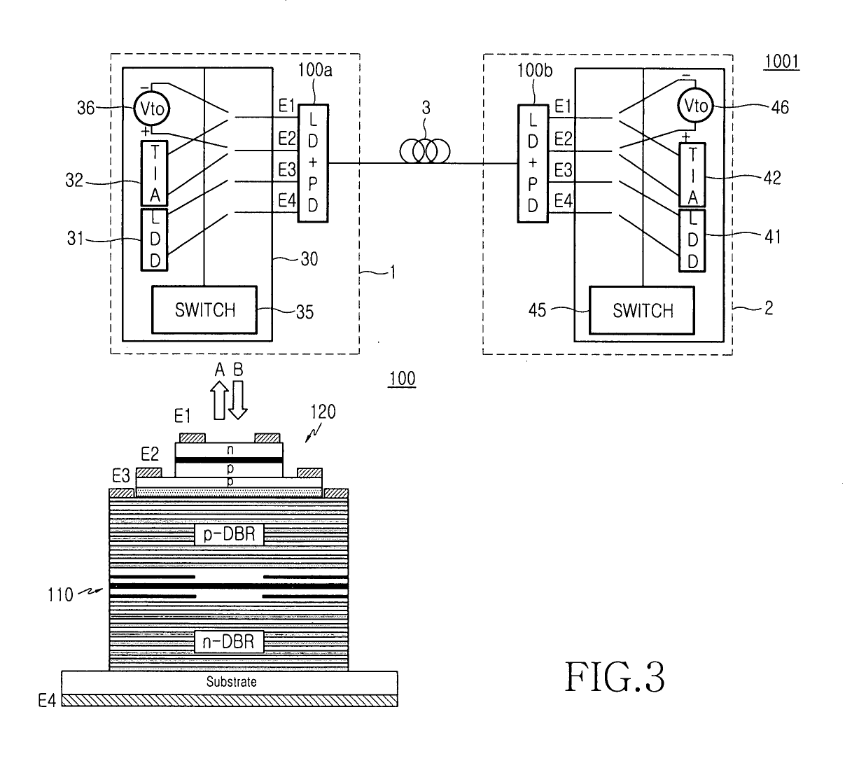

FIG. 3 is a schematic view illustrating a case 1001 in which the photodetector integrated vertical cavity surface emitting laser of FIG. 2 is applied to the optical connection structure of FIG. 1. The operation of the optical connection in the half-duplex type is described with reference to FIG. 3. For reference, the photodetector integrated vertical cavity surface emitting lasers 100a and 100b are similar in construction to the photodetector integrated vertical cavity surface emitting laser 100 shown in FIG. 2. Therefore, for the convenience of description of operation, the individual layers of the photodetector integrated vertical cavity emitting lasers 100a and 100b and reference numerals thereof are not described.

When the first signal transmitting/receiving unit 1 transmits signals to the second signal transmitting/receiving unit 2, switch 35, in transmitting/receiving unit 1, is positioned in the control unit 30, such that the top electrode E3 and the bottom electrode E4 of the light source 110 of the photodetector integrated VCSEL 100a are connected with the light source driver (LDD) 31 and the top electrode E1 and the bottom electrode E2 of the photodetector 120 are connected with the voltage source 36, thereby forwardly applying a bias voltage to the extent of a turn-on voltage. Consequently, the first signal transmitting/receiving unit 1 produces a laser beam that passes through the photodetector 120 and transmitting the laser beam to the second light transmitting/receiving unit 2 through the optical waveguide 3.

At this time, switch 45, positioned in the control unit 40 in the second signal transmitting/receiving unit 2, applies a reverse voltage to the top electrode E1 and the bottom electrode E2 of the photodetector 120 and the laser diode 110 is turned off. Consequently, the second signal transmitting/receiving unit 2 is operated in the signal receiving mode and receives optical signal (“A”) transmitted through the optical waveguide 3 from the first signal transmitting/receiving unit 1.

Because the first signal transmitting/receiving unit 1 and the second signal transmitting/receiving unit 2 are identical in construction, the second signal transmitting/receiving unit 2 is able to transmit signals to the first signal transmitting/receiving unit 1 in opposition to the above-mentioned case.

More specifically, in the second signal transmitting/receiving unit 2, the top electrode E3 and the bottom electrode E4 of the laser diode 110 of the photodetector integrated vertical cavity surface emitting laser 100b are connected with the light source driver (LDD) 41 and the top electrode E1 and the bottom electrode E2 of the photodetector 120 are connected with the voltage source 46, whereby a bias voltage is forwardly applied to the extent of a turn-on voltage. A reverse voltage is applied to the top electrode E1 and the bottom electrode E2 of the photodetector 120 of the photodetector integrated vertical cavity surface emitting laser 100a positioned in the first signal transmitting/receiving unit 1, and the light source 110 is turned off. Consequently, the second signal transmitting/receiving unit 2 is operated in the signal transmitting mode and the first signal transmitting unit 1 is operated in the signal receiving mode.

As described above, in the half-duplex transmission type, a communication unit is not required to simultaneously execute both signal transmission and signal reception. Therefore, it is possible to reduce the number of optical devices necessary for an entire optical connection by half when a laser diode and a photo diode are integrated as a single chip.

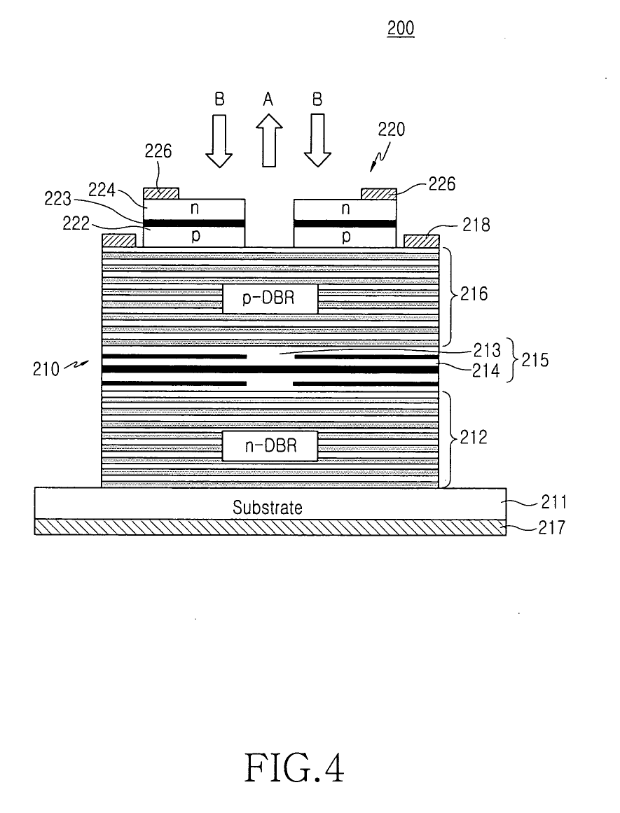

FIG. 4 is a schematic view illustrating another example of a photodetector integrated vertical cavity surface emitting laser suitable for the half-duplex type optical connection structure in accordance with the principles of the invention. The construction shown in FIG. 4 is different from that of FIG. 2 in that the construction of the latter an isolation layer is needed to apply a forward bias voltage to the photodetector to the extent of a turn-on voltage simultaneously while driving the laser diode when it is operated in the signal transmitting mode, while the invention described in FIG. 4 is designed to be capable of being operated without an isolation layer.

Referring to FIG. 4, the photodetector integrated vertical cavity surface emitting laser 200 includes a light source 210, and a photodetector 220 of p-i-n structure, which is formed on the top of the light source 210.

The light source 210 includes an n-doped GaAs substrate 211, a lower reflector layer 212, which is formed by laminating plural mirrors of n-type semiconductor material on the top of the substrate 211, an active layer 215 formed on the top of the lower reflector layer 212, an upper reflector layer 216, which is formed by laminating plural mirrors, which are formed of p-type semiconductor material, on the top of the active layer 215, a bottom electrode 217 formed on the rear side of the substrate 211, and a top electrode 218 coupled to the top of electrode 216 and has a central cavity. In addition, the active layer 215 has a current concentration area 213, to which electric current is concentrated, and a high resistance area for suppressing the spontaneous emission of light which is laterally projected.

When a voltage for driving the laser diode, V_{LD}, is applied to the bottom electrode 217 and the top electrode 218 is earthed (grounded), a laser beam, shown as arrow “A”, is produced from the active layer 215 by the applied voltage.

As being reflected from the lower and upper reflector layers 212 and 216 of high reflectivity, the produced laser beam is amplified. When the produced laser beam arrives at a predetermined wavelength, the laser beam passes through the two reflector layers and is projected in the opposite directions perpendicular to the substrate 211.

The photodetector 220 is laminated over the cavity of the light source 210 and includes a p-type doped layer 220, a light absorbing layer 223, an n-type doped layer 224, and an electrode 226. The photodetector 220 has a hole formed through the center of the p-i-n structure, so that the cavity of the light source 210 is partially exposed. This is to allow the laser beam, which is produced from the lower light source 210, to pass through the photodetector 220 without applying a forward bias voltage to the p-i-n structure.

However, when the photodetector integrated vertical cavity light emitting laser 200 of FIG. 4 is operated in the signal receiving mode, the part corresponding to the hole-formed area cannot receive optical signals. Therefore, the optical signal receiving sensitivity may be reduced when compared with that shown in FIG. 2.

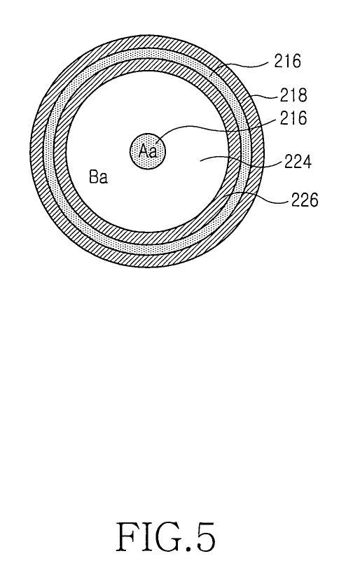

As shown in FIG. 5, which is a top view of the photodetector integrated vertical cavity light emitting laser (VCSEL), the laser beam passing area “Aa” is considerably smaller when compared with the entire light receiving area “Ba.” Thus, the loss in optical signal receiving sensitivity is not significantly degraded. For example, a conventional multi-mode vertical cavity surface emitting laser (VCSEL) has a diameter of about 15 micrometers (μm). However, a single mode vertical cavity surface emitting laser has a diameter which is considerably smaller than that of the multi-mode vertical cavity surface emitting laser and the diameter of the p-i-n structure is in the range of about 100 to 200 μm. Accordingly, it can be said that the loss in optical signal receiving sensitivity is very low.

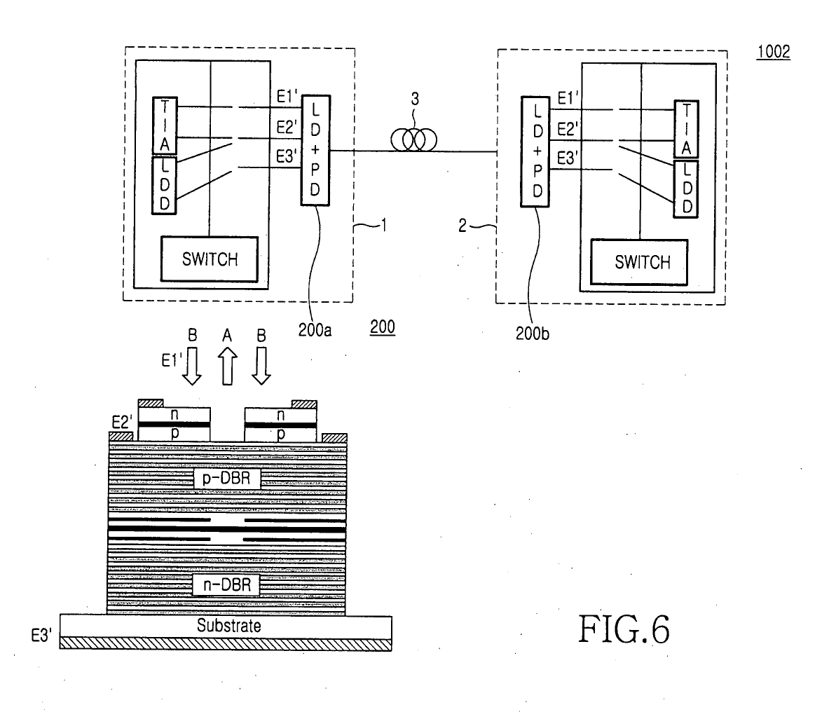

FIG. 6 shows a case 1002, in which the photodetector integrated vertical cavity surface emitting laser of FIG. 4 is applied to the optical connection structure of FIG. 1. The light connecting operation in this regard is now described. As the photodetector integrated vertical cavity surface emitting lasers 200a and 200b of FIG. 6 have a same construction as that shown in FIG. 4, the description for individual layers and reference numerals thereof is omitted for the convenience in describing the operation.

In this illustrative system, the first signal transmitting/receiving unit 1 transmits signals to the second signal transmitting/receiving unit 2. The signals are generated in the first signal transmitting/receiving unit 1, by the switch in the control unit being positioned such that the top electrode E2′ and the bottom electrode E3′ of the light source 210 of the photodetector integrated vertical cavity surface emitting laser 200a are connected to the light source driver (LDD) and the top electrode E1′ and the bottom electrode E2′ of the photodetector 220 are cut off from each other (the top and bottom electrodes E1′ and E2′ are disconnected from the transimpedance amplifier (TIA)). Consequently, the first signal transmitting/receiving unit 1 allows the laser beam (“A”), which is produced from the light source 210, to pass through a central hole, thereby transmitting the beam to the second signal transmitting/receiving unit 2 through the optical waveguide 3.

The second signal transmitting/receiving unit 2, at this time, by properly positioning the contained switch, a reverse voltage is applied to the top electrode E1′ and the bottom electrode E2′ of the photodetector 220 (the top and bottom electrodes E1′ and E2′ are connected with the transimpedance amplifier (TIA)), and the light source is turned off (the light source and the light source driver are disconnected from each other). Consequently, the second signal transmitting/receiving unit 2 is operated in the signal receiving mode and receives the optical signals “A” transmitted through the optical waveguide 3, thereby producing electric current.

Because the first signal transmitting/receiving unit 1 and the second signal transmitting/receiving unit 2 are similar in construction, the second signal transmitting unit 2 may transmit signals to the first signal transmitting/receiving unit 1 in a manner similar to that described above.

More specifically, in the second signal transmitting/receiving unit 2, the top electrode E2′ and the bottom electrode E3′ of the light source 210 of the photodetector integrated vertical cavity surface emitting laser 200b are connected with the light source driver LDD, and the top electrode E1′ and the bottom electrode E2′ of the photodetector 220 are cut off. In addition, in the first signal transmitting/receiving unit 1, a reverse voltage is applied to the top electrode E1′ and the bottom electrode E2′ of the photodetector 120 of the photodetector integrated vertical cavity surface emitting laser 200a, and the light source 110 is turned off (i.e., the light source and the light source driver LDD are disconnected from each other). Consequently, in the half-duplex transmission type, as it is not necessary for one communication unit to simultaneously execute both signal transmission and signal reception, it is possible to reduce the number of optical devices required for an entire optical connection when an optical device is employed which is formed by integrating a laser diode and a photo diode as a single chip, as described herein.

As described above, by providing optical devices, each of which is formed by integrating a light source and a photodetector as a single chip, and configuring an optical connection in such a manner that the optical devices can be applied to a half-duplex transmission type, the present invention can reduce the number of optical devices required for an entire optical connection.

In addition; according to the present invention, the manufacturing process of optical devices can be simplified. Furthermore, there is an advantage in securing a space required for optical connection.

Therefore, the present invention is useful, in particular, in a technical field where a space for mounting an optical connection is very limitative and the costs of parts should be reduced, like a field of wireless terminal.

While the invention has been shown and described with reference to certain preferred embodiments thereof, various changes and modifications can be made without departing from the scope and spirit of the present invention as defined by the appended claims. Therefore, the scope of the present invention shall be determined by the appended claims and equivalents thereof rather than by the embodiments described above.

What is claimed is:

1. An optical connection structure of half-duplex type comprising:
two or more signal transmitting/receiving units, which are interconnected through an optical waveguide, wherein each of the signal transmitting/receiving units comprises:
an optical device having a light source for producing and emitting optical signals to through an opening, and a photodetector for receiving the optical signals incident thereto and converting the optical signals into electric signals, the light source and the photodetector being integrated with each other; and
a control unit, which, in the signal transmitting mode, drives the light source, so that the corresponding signal transmitting/receiving unit functions as a light source, and in the signal receiving mode, and drives the photodetector, so that the corresponding signal transmitting/receiving unit functions as a photodetector.

2. An optical connection structure as claimed in claim 1, wherein the control unit comprises:
a light source driver for driving the light source of the optical device;
a transimpedance amplifier (TIA) for amplifying and outputting the electric signals supplied from the photodetector; and
a switch, which, in the signal transmitting mode, interconnects the light source driver and the light source, and in the signal receiving mode, electrically interconnects the photodetector and the transimpedance amplifier.

3. An optical connection structure as claimed in claim 1, wherein the optical device comprises:
a substrate; and
a vertical cavity surface emitting laser (VCSEL) provided on the substrate, the vertical cavity surface emitting laser producing and emitting optical signals through the opening or to receive optical signals.

4. An optical connection structure as claimed in claim 1, wherein the optical device comprises:
a substrate;
a vertical cavity surface emitting laser (VCSEL) provided on the substrate, the vertical cavity surface emitting laser producing and emitting optical signals to the outside through the opening; and
a photo detecting unit provided on the top of the vertical cavity surface emitting laser, the photo detecting unit passing light emitted by the vertical cavity surface emitting laser and receiving optical signals, and converting the received optical signals to electric signals.

5. An optical connection structure as claimed in claim 4, wherein the vertical cavity surface emitting laser comprises:
a lower reflector layer formed by laminating plural mirrors of n-type semiconductor material on the substrate;
an active layer laminated on the lower reflector layer to produce light;
an upper reflector layer formed by laminating plural mirrors, which are formed of p-type semiconductor material, on the active layer;
a bottom electrode formed on the rear side of the substrate; and
a top electrode formed on the top of the upper layer and having a cavity, through which the light produced from the active layer is projected.

6. An optical connection structure as claimed in claim 5, wherein the active layer comprises:
a current concentration area which is formed on a part of the active layer facing the cavity and to which current is concentrated, so that the laser beam is substantially produced from the current concentration area; and
a high resistance area formed on a part of the active layer, which does not face the cavity.

7. An optical connection structure as claimed in claim 5, wherein the optical device further comprises:
an isolation layer formed over the cavity of the top electrode, thereby electrically isolating the vertical cavity surface emitting laser and the photodetector from each other.

8. An optical connection structure as claimed in claim 7, wherein the optical detector is a photo diode of p-i-n structure laminated on the isolation layer.

9. An optical connection structure as claimed in claim 8, wherein each of the signal transmitting/receiving units further comprises:
a voltage source for applying a forward bias voltage to the photo diode of p-i-n structure to the extent of turn-on voltage.

10. An optical connection structure as claimed in claim 5, wherein the photodetector is a photo diode of p-i-n structure laminated over the cavity of the top electrode, and the photo diode has a opening through which the beam produced from the vertical cavity surface emitting laser is adapted to be projected.

11. A photodetector integrated vertical cavity surface emitting laser comprising:
a substrate;
a vertical cavity surface emitting laser (VCSEL) provided on the substrate, the vertical cavity surface emitting laser producing and emitting optical signals through an opening; and
a photo detecting unit provided on the top of the vertical cavity surface emitting laser, the photo detecting unit passing light emitted by the vertical cavity surface emitting laser and receiving optical signals incident thereto so as to convert the optical signals to electric signals.

12. A photodetector integrated vertical cavity surface emitting laser as claimed in claim 11, wherein the vertical cavity surface emitting laser comprises:
a lower reflector layer formed by laminating plural mirrors of n-type semiconductor material on the substrate;
an active layer laminated on the lower reflector layer to produce light;
an upper reflector layer formed by laminating plural mirrors, which are formed of p-type semiconductor material, on the active layer;
a bottom electrode formed on the rear side of the substrate; and
a top electrode formed on the top of the upper layer and having a cavity, through which the light produced from the active layer is projected.

13. A photodetector integrated vertical cavity surface emitting laser as claimed in claim 12, wherein the active layer comprises:
a current concentration area which is formed on a part of the active layer facing the cavity and to which current is concentrated, so that the laser beam is substantially produced from the current concentration area; and
a high resistance area formed on a part of the active layer, which does not face the cavity.

14. A photodetector integrated vertical cavity surface emitting laser as claimed in claim 12, wherein the optical device further comprises:
an isolation layer formed over the cavity of the top electrode, thereby electrically isolating the vertical cavity surface emitting laser and the photodetector from each other.

15. A photodetector integrated vertical cavity surface emitting laser as claimed in claim 14, wherein the optical detector is a photo diode of p-i-n structure laminated on the isolation layer.

16. A photodetector integrated vertical cavity surface emitting laser as claimed in claim 12, wherein the photodetector is a photo diode of p-i-n structure laminated over the cavity of the top electrode, and the photo diode has an opening, through which the beam produced from the vertical cavity surface emitting laser is projected.

17. A photodiode integrated light source suitable for transmission and receiving of optical signals, comprising:
a light source for producing and emitting optical signals through an opening,
a photodetector for receiving the optical signals incident thereto and converting the optical signals into electric signals, the light source and the photodetector being integrated with each other; and
a control unit, which, in a signal transmitting mode, drives the light source, so that the corresponding signal transmitting/receiving unit functions as a light source, and in a signal receiving mode, drives the photodetector, so that the corresponding signal transmitting/receiving unit functions as a photodetector.

18. The photodiode integrated light source as claimed in claim 17, wherein the control unit comprises:
a light source driver for driving the light source of the optical device;
a transimpedance amplifier (TIA) for amplifying and outputting the electric signals supplied from the photodetector; and
a switch, which, in the signal transmitting mode, interconnects the light source driver and the light source, and in the signal receiving mode, electrically interconnects the photodetector and the transimpedance amplifier.

19. The photodiode integrated light source as claimed in claim 17, wherein the light source is a vertical cavity surface emitting laser (VCSEL) emitting optical signals through an opening and the photodetector unit is provided on a top of the vertical cavity surface emitting laser, the photodetector passing light emitted by the vertical cavity surface emitting laser.
